(19) United States
(12) Patent Application Publication
(10) Pub. No.: US 2010/0004423 A1
(43) Pub. Date: Jan. 7, 2010

(54) PROCESS FOR PREPARATION OF REGIOREGULAR POLY(3-SUBSTITUTED-THIOPHENE)

(75) Inventor: Reuben Rieke, Lincoln, NE (US)

Correspondence Address: SCHWEGMAN, LUNDBERG & WOESSNER, P.A., P.O. BOX 2938, MINNEAPOLIS, MN, 55402, US

(73) Assignee: RIEKE METALS INC., Lincoln, NE (US)

(21) Appl. No.: 12/308,024

(22) PCT Filed: Jun. 7, 2006
(86) PCT No.: PCT/US2007/013436

§ 371 Date: May 11, 2009

Related U.S. Application Data
(60) Provisional application No. 60/804,139, filed on Jun. 7, 2006.

(51) Int. Cl. C08G 75/08

(52) U.S. Cl. 528/380

(57) ABSTRACT

The invention provides a method of preparing regioregular HT poly(3-substituted-thiophene). The method includes contacting a 3-substituted-thiophene-metal complex with a manganese(II) halide to provide a 3-substituted-thiophene-manganese complex; and contacting the thiophene-manganese complex with a nickel(II) catalyst to provide the regioregular HT poly(3-substituted-thiophene). The substitution at the 3-position can be a variety of different groups. Additionally, unsubstituted and 3,4-disubstituted polythiophenes can also be prepared by the method. Electronic devices can be made using the polymers prepared as described herein.

### RELATED APPLICATIONS

This application claims priority under 35 U.S.C. §119(e) to U.S. Application Ser. No. 60/804,139, filed Jun. 7, 2006, which application is incorporated herein by reference.

### FIELD OF INVENTION

The invention relates to an improved process for making substituted polythiophene polymers having high regioselectivity in a more efficient and less costly manner.

### BACKGROUND OF THE INVENTION

Polythiophenes have received significant attention recently due to their nonlinear optical properties, electro-conductivity, and other valuable properties. They can be employed in electrical components such as transistors, diodes, and triodes in a variety of applications. The use of polythiophenes for these and other applications has often been hampered by irregular conductivity due a lack of purity.

There are several known synthetic methods for preparing polythiophene. These known techniques, however, often provide substituted polythiophenes that have a less than optimal regiospecificity. Highly regioregular polythiophenes are desired because monomer orientation has a great influence on the electro-conductivity of the polymer. A highly regioregular polythiophene allows for improved packing and optimized microstructure, leading to improved charge carrier mobility.

Accordingly, there remains a need for improved synthetic methods for high purity and highly regioregular polythiophene polymers. Also needed are devices with high purity regioregular polythiophene polymer components for improved ease of manufacture and device operation.

### SUMMARY

The invention is directed to a method of preparing a regioregular polythiophene. The polythiophene can be a 3-substituted polythiophene. The polythiophene can also be a 3,4-disubstituted polythiophene or an unsubstituted polythiophene.

The method of preparing regioregular head-to-tail (“HT”) poly(3-substituted-thiophene) includes contacting a 3-substituted-thiophene-metal complex with a manganese(II) halide to provide a 3-substituted-thiophene-manganese complex; and contacting the thiophene-manganese complex with a nickel (II) catalyst to provide the regioregular HT poly(3-substituted-thiophene). Alternatively, the nickel(II) catalyst and the thiophene-manganese complex may be contacted to provide the regioregular HT poly(3-substituted-thiophene). The 3-substituted-thiophene-metal complex can be prepared by a method that includes contacting a 2,5-dihalo-3-substituted-thiophene and an organometallic reagent to provide the 3-substituted-thiophene-metal complex. The organometallic reagent can be a Grignard reagent, a Grignard-ate complex, an alkyl lithium reagent, an alkyl lithium cuprate, an alkyl aluminum reagent, or an organozinc reagent.

The invention is also directed to a conductive polymer composed of an improved regioregular polythiophene having superior electroconductive properties. The improved polythiophene is characterized by its monomeric composition, its degree of regioregularity, and its physical properties such as its molecular weight and number average molecular weight, its polydispersity, its conductivity, its purity obtained directly from its preparatory features, as well as other properties. The improved polythiophene is characterized as well by the process for its preparation. In particular, the HT regioregularity of the improved polythiophene of the invention can be at least about 85%, preferably at least about 87%, more preferably at least about 90%, even more preferably at least about 92%, yet more preferably at least about 95%, further preferably at least about 97%, or most preferably at least about 99%.

The invention is as well directed to a thin film of a polythiophene prepared by the methods described herein. The polythiophene film can include a dopant. In another aspect of the invention, the polythiophene film can be employed to prepare a radio frequency identification (RFID) tag, a plastic lighting device, or an organic light-emitting diode (OLED), such as in an electronic display.

### DEFINITIONS

As used herein, certain terms have the following meanings. All other terms and phrases used in this specification have their ordinary meanings as one of skill would understand. Such ordinary meanings may be obtained by reference to technical dictionaries, such as Hawley 's Condensed Chemical Dictionary 11^{th} Edition, by Sax and Lewis, Van Nostrand Reinhold, New York, N.Y., 1987; and The Merck Index, 11^{th} Edition, Merck & Co., Rahway N.J. 1989.

As used herein, the term “and/or” means any one of the items, any combination of the items, or all of the items with which this term is associated.

As used herein, the singular forms “a,” “an,” and “the” include plural reference unless the context clearly dictates otherwise. Thus, for example, a reference to “a formulation” includes a plurality of such formulations, so that a formulation of compound X includes formulations of compound X.

As used herein, the term “about” means a variation of 10 percent of the value specified; for example, about 50 percent carries a variation from 45 to 55 percent. For integer ranges, the term about can include one or two integers greater than and less than a recited integer.

As used herein, the term “alkyl” refers to a branched, unbranched, or cyclic hydrocarbon-having, for example, from 1 to 30 carbon atoms, and often 1 to 12 carbon atoms. Examples include, but are not limited to, methyl, ethyl, 1-propyl (n-propyl), 2-propyl i-propyl), 1-butyl (n-butyl), 2-methyl-1-propyl (i-butyl), 2-butyl (sec-butyl), 2-methyl-2-propyl (t-butyl), 1-pentyl (n-pentyl), 2-pentyl, 3-pentyl, 2-methyl-2-butyl, 3-methyl-2-butyl, 3-methyl-1-butyl, 2-methyl-1-butyl, 1-hexyl, 2-hexyl, 3-hexyl, 2-methyl-2-pentyl, 3-methyl-2-pentyl, 4-methyl-2-pentyl, 3-methyl-3-pentyl, 2-methyl-3-pentyl, 2,3-dimethyl-2-butyl, 3,3-dimethyl-2-butyl, hexyl, octyl, decyl, dodecyl, and the like. The alkyl can be unsubstituted or substituted. The alkyl can also be optionally partially or fully unsaturated. As such, the recitation of an alkyl group includes both alkenyl and alkynyl groups. The alkyl can be a monovalent hydrocarbon radical, as described and exemplified above, or it can be a divalent hydrocarbon radical (i.e., alkylene).

As used herein, the term “alkylthio” refers to the group alkyl-S—, where alkyl is as defined herein. In one embodiment, alkylthio groups include, e.g., methylthio, ethylthio, n-propylthio, iso-propylthio, n-butylthio, tert-butylthio, sec-butylthio, n-pentylthio, n-hexylthio, 1,2-dimethylbutylthio, and the like. The alkyl group of the alkylthio can be unsubstituted or substituted.

As used herein, the term “alkylsilyl” refers to the group alkyl-SiH₂— or alkyl-SiR₂—, where alkyl is as defined herein, and each R is independently H or alkyl. Thiophenes can be substituted by alkylsilyl groups by any of the many techniques known to those of skill in the art, typically by coupling the thiophene with an alkylsilyl halide, many of which are disclosed in the Aldrich Handbook of Fine Chemicals, 2007-2008, Milwaukee, Wis.

As used herein, the term “alkoxy” refers to the group alkyl-O—, where alkyl is as defined herein. In one embodiment, alkoxy groups include, e.g., methoxy, ethoxy, n-propoxy, iso-propoxy, n-butoxy, tert-butoxy, sec-butoxy, n-pentoxy, n-hexoxy, 1,2-dimethylbutoxy, and the like. The alkyl group of the alkoxy can be unsubstituted or substituted.

As used herein, the term “aryl” refers to an aromatic hydrocarbon group derived from the removal of one hydrogen atom from a single carbon atom of a parent aromatic ring system. The radical can be at a saturated or unsaturated carbon atom of the parent ring system. The aryl group can have from 6 to 18 carbon atoms. The aryl group can have a single ring (e.g., phenyl) or multiple condensed (fused) rings, wherein at least one ring is aromatic (e.g., naphthyl, dihydrophenanthrenyl, fluorenyl, or anthryl). Typical aryl groups include, but are not limited to, radicals derived from benzene, naphthalene, anthracene, biphenyl, and the like. The aryl can be unsubstituted or optionally substituted, as described above for alkyl groups.

As used herein, the terms “film” or “thin film” refers to a self-supporting or free-standing film that shows mechanical stability and flexibility, as well as a coating or layer on a supporting substrate or between two substrates.

As used herein, the term “Grignard-ate complex” refers to the complexing or three-dimensional association of one or more Grignard reagents with an alkali salt to form to form the three-dimensional ate complex.

As used herein, the terms “halo” and “halogen” refer to a fluoro, chloro, bromo, or iodo group, substituent, or radical.

As used herein, the term “high purity” refers to a compound or polymer that is at least about 85%, preferably at least about 87%, more preferably at least about 90%, even more preferably at least about 92%, yet more preferably at least about 95%, further preferably at least about 97%, or most preferably at least about 99% pure. The purity can be determined in a wt. %/wt. % manner.

As used herein, the term “heteroaryl” is defined herein as a monocyclic, bicyclic, or tricyclic ring system containing one, two, or three aromatic rings and containing at least one nitrogen, oxygen, or sulfur atom in an aromatic ring, and which can be unsubstituted or substituted, for example, with one or more, and in particular one to three, substituents, as described above in the definition of “substituted.” Examples of heteroaryl groups include, but are not limited to, 2H-pyrrolyl, 3H-indolyl, 4H-quinolizinyl, acridinyl, benzo[b]thienyl, benzothiazolyl, β-carbolinyl, carbazolyl, chromenyl, cinnolinyl, dibenzo[b,d]furanyl, furazanyl, furyl, imidazolyl, imidizolyl, indazolyl, indolisinyl, indolyl, isobenzofuranyl, isoindolyl, isoquinolyl, isothiazolyl, isoxazolyl, naphthyridinyl, oxazolyl, perimidinyl, phenanthridinyl, phenanthrolinyl, phenarsazinyl, phenazinyl, phenothiazinyl, phenoxathiinyl, phenoxazinyl, phthalazinyl, pteridinyl, purinyl, pyranyl, pyrazinyl, pyrazolyl, pyridazinyl, pyridyl, pyrimidinyl, pyrimidinyl, pyrrolyl, quinazolinyl, quinolyl, quinoxalinyl, thiadiazolyl, thianthrenyl, thiazolyl, thienyl, triazolyl, tetrazolyl, and xanthenyl. In one embodiment the term “heteroaryl” denotes a monocyclic aromatic ring containing five or six ring atoms containing carbon and 1, 2, 3, or 4 heteroatoms independently selected from non-peroxide oxygen, sulfur, and N(Z) wherein Z is absent or is H, O, alkyl, aryl, or (C₁-C₆)alkylaryl. In another embodiment heteroaryl denotes an ortho-fused bicyclic heterocycle of about eight to ten ring atoms derived therefrom, particularly a benz-derivative or one derived by fusing a propylene, trimethylene, or tetramethylene diradical thereto.

As used herein, the terms “heterocycle” or “heterocyclyl” refer to a saturated or partially unsaturated ring system, containing at least one heteroatom selected from the group oxygen, nitrogen, and sulfur, and optionally substituted with one or more groups as defined herein under the term “substituted.” A heterocycle can be a monocyclic, bicyclic, or tricyclic group containing one or more heteroatoms. A heterocycle group also can contain an oxo group (═O) attached to the ring. Non-limiting examples of heterocycle groups include 1,3-dihydrobenzofuran, 1,3-dioxolane, 1,4-dioxane, 1,4-dithiane, 2H-pyran, 2-pyrazoline, 4H-pyran, chromanyl, imidazolidinyl, imidazolinyl, indolinyl, isochromanyl, isoindolinyl, morpholine, piperazinyl, piperidine, piperidyl, pyrazolidine, pyrazolidinyl, pyrazolinyl, pyrrolidine, pyrroline, quinuclidine, and thiomorpholine. The term “heterocycle” also includes, by way of example and not limitation, a monoradical of the heterocycles described in Paquette, Leo A.; Principles of Modern Heterocyclic Chemistry (W. A. Benjamin, New York, 1968), particularly Chapters 1, 3, 4, 6, 7, and 9; The Chemistry of Heterocyclic Compounds, A Series of Monographs” (John Wiley & Sons, New York, 1950 to present), in particular Volumes 13, 14, 16, 19, and 28; and J. Am. Chem. Soc. 1960, 82, 5566. In one embodiment of the invention “heterocycle” includes a “carbocycle” as defined herein, wherein one or more (e.g. 1, 2, 3, or 4) carbon atoms have been replaced with a heteroatom (e.g. O, N, or S).

As used herein, the term “HT poly(3-substituted-thiophene)” refers to the head-to-tail orientation of monomers in a poly(3-substituted-thiophene). The percent regioregularity present in an HT poly(3-substituted-thiophene) can be determined by standard ¹H NMR techniques. The percent regioregularity can be increased by various techniques, including Soxhlet extraction, precipitation, and recrystallization.

As used herein, the term “regioregular” refers to a polymer where the monomers are arranged in a substantially head-to-tail orientation. For further description and discussion of the terms regiorandom and regioregular (or regioselective), see U.S. Pat. No. 5,756,653, the disclosure of which is incorporated by reference herein.

As used herein, the term “room temperature” refers to about 23° C.

As used herein, the term “substituted” is intended to indicate that one or more (e.g., 1, 2, 3, 4, or 5; in some embodiments 1, 2, or 3; and in other embodiments 1 or 2) hydrogen atoms on the group indicated in the expression using “substituted” is replaced with a selection from the indicated organic or inorganic group(s), or with a suitable organic or inorganic group known to those of skill in the art, provided that the indicated atom's normal valency is not exceeded, and that the substitution results in a stable compound. Suitable indicated organic or inorganic groups include, e.g., alkyl, alkenyl, alkynyl, alkoxy, halo, haloalkyl, hydroxy, hydroxyalkyl, aryl, heteroaryl, heterocyclyl, cycloalkyl, alkanoyl, alkoxycarbonyl, amino, alkylamino, dialkylamino, trifluoromethylthio, difluoromethyl, acylamino, nitro, trifluoromethyl, trifluoromethoxy, carboxy, carboxyalkyl, keto, thioxo, alkylthio, alkylsulfinyl, alkylsulfonyl, alkylsilyl, and cyano. Additionally, the suitable indicated groups can include, e.g., —X, —R, —O⁻, —OR, —SR, —S⁻, —NR₂, —NR₃, ═NR, —CX₃, —CN, —OCN, —SCN, —N═C═O, —NCS, —NO, —NO₂, ═N₂, —N₃, NC(═O)R, —C(═O)R, —C(═O)NRR —S(═O)₂O⁻, —S(═O)₂OH, —S(═O)₂R, —OS(═O)₂OR, —S(═O)₂NR, —S(═O)R, —OP(═O)O₂RR —P(═O)O₂RR, —P(═O)(O⁻)₂, —P(═O)(OH)₂, —C(═O)R, —C(═O)X, —C(S)R, —C(O)OR, —C(O)O⁻, —C(S)OR, —C(O)SR, —C(S)SR, —C(O)NRR, —C(S)NRR, or —C(NR)NRR, where each X is independently a halogen (or “halo” group): F, Cl, Br, or 1; and each R is independently H, alkyl, aryl, heterocyclyl, a protecting group, or a prodrug moiety. As would be readily understood by one skilled in the art, when a substituent is keto (i.e., ═O) or thioxo (i.e., ═S), or the like, then two hydrogen atoms on the substituted atom are replaced.

As used herein, the terms “stable compound” and “stable structure” are meant to indicate a compound or polymer that is sufficiently robust to survive isolation to a useful degree of purity from a reaction mixture. The compounds and polymers of the present invention are typically stable compounds. Intermediates and metal complexes can be somewhat instable or non-isolable components of the methods of the invention.

As used herein, the term “thiophene-metal complex” refers to a thiophene moiety that is associated with a metal. The association can be a covalent bond or the association can have both covalent and ionic bonding character. The complex can be an “ate-complex,” wherein more than one metal atom and/or more than one thiophene moiety is associated with each other.

As used herein, the term “thiophene-manganese complex” refers to a thiophene moiety that is associated with a manganese atom. The thiophene-manganese complex is typically a thiophene-manganese halide complex. The halide, or “halo” group can be fluoro, chloro, bromo, or iodo.

As to any of the above groups, which contain one or more substituents, it is understood, of course, that such groups do not contain any substitution or substitution patterns that are sterically impractical and/or synthetically non-feasible. In addition, the compounds of this invention include all stereochemical isomers arising from the substitution of these compounds.

### DETAILED DESCRIPTION OF THE INVENTION

### General Preparatory Methods

A number of exemplary methods for the preparation of polymers of the invention are provided herein. These methods are intended to illustrate the nature of such preparations and are not intended to limit the scope of applicable methods. Certain compounds can be used as intermediates for the preparation of other compounds or polymers of the invention.

A general scheme for preparing polythiophenes is provided below.

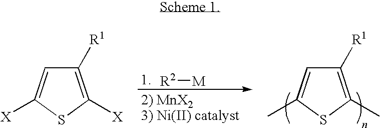

wherein X is a halogen, R¹ is an alkyl, alkylthio, alkylsilyl, or alkoxy group that is optionally substituted with one to about five ester, ketone, nitrile, amino, halo, aryl, heteroaryl, or heterocyclyl groups, and the alkyl chain of the alkyl group is optionally interrupted by one to about ten O, S, and/or NP groups wherein P is a substituent as described above or a nitrogen protecting group; R²—M is an organometallic reagent that can react with the thiophene to form a thiophene metal complex that undergoes transmetallation when introduced to a manganese(II) salt, such as MnF₂, MnCl₂, MnBr₂, or MnI₂; and the Ni(II) catalyst is any nickel(II) catalyst that effectuates polymerization of the thiophene manganese complex.

The invention relates to the transmetallation of a thiophene-metal complex with manganese salts to provide a thiophene-manganese complex that undergoes facile polymerization with a Ni(II) catalyst. The thiophene-metal complex is typically substituted by a metal at the 2- or 5-position, for example, by the exchange of the metal for a halogen that was positioned at the 2- or 5-position. The thiophene-metal complex can then be converted to a thiophene-manganese complex by transmetallation. Thereafter, the thiophene-manganese complex can be readily polymerized by a Ni(II) catalyst to provide a highly regioregular 3-substituted polythiophene. Although it is not intended to be a limitation of the invention, it is believed that transmetallation to provide the thiophene-manganese complex reduces the activation energy or energetic barrier for polymerizing the thiophene-based monomer. The use of a thiophene-manganese complex thus is believed to provide a more energetic polymerization that does not require additional heating, and the resulting polymer has a higher regioregularity than does a polymer produced by heretofore known methods.

In particular, for example, a 2,5-dihalo-3-substituted-thiophene can be dissolved in a suitable solvent, such as an ethereal solvent, for example, tetrahydrofuran. The reaction flask can be cooled before introduction of the organometallic reagent. The organometallic reagent can be added into the reaction flask and stirred for a sufficient period of time to form the thiophene-metal complex by exchanging a group on the organometallic complex with one of the X (halo) groups of the thiophene. After the thiophene-metal complex has formed, a manganese halide can be added to the reaction mixture, optionally allowing the reaction to warm to ambient temperature, to afford a transmetallated species.

After transmetallation, the reaction can be allowed to settle and the solution of the reaction vessel can be transferred to a flask containing a nickel(II) catalyst, optionally dissolved in an ethereal solvent. Alternatively after transmetallation, the flask containing the nickel(II) catalyst may be added to the reaction vessel containing the transmetallated species. The resulting mixture can be stirred for a sufficient amount of time to effect the formation of the polythiophene, which typically precipitates from the reaction mixture. The polythiophene can be isolated by transferring the reaction mixture into a volume of solvent in which the polythiophene is substantially insoluble. Further work-up can include filtering, washing with methanol, and drying under high vacuum. Additional purification can be carried out by Soxhlet extraction with, for example, a hydrocarbon solvent, such as hexanes.

The formation of the polythiophene can be carried out at any suitable and effective temperature. In one embodiment, the polymerization is carried out at temperatures of about −100° C. to about 150° C. In another embodiment, the polymerization is conducted at temperatures of about −20° C. to about 100° C. The polymerization can be carried out in the same solvent as was the preparation of the thiophene metal complex. The polymerization reaction step with the Ni(II) catalyst can be carried out at about 0° C. to about the boiling point of the solvent used in this step of the reaction. Typically, the thiophene-manganese complex is contacted with the nickel(II) catalyst at about −80° C. to about 35° C., or preferably at about −10° C. to about 30° C., or more preferably at about 0° C. to about 27° C.

One advantage of the methods described herein for preparing polythiophenes, however, is that transmetallation of the thiophene-metal complex with manganese allows for polymerization at a lower temperature than many known methods, such as those described in U.S. Pat. No. 6,166,172. Polymerization of the thiophene-manganese complex proceeds smoothly at ambient temperatures (e.g., about 18° C. to about 25° C.) without the need for a heat source or for refluxing conditions. A more significant advantage is that the method described herein produces a polymer of greater regioregularity (higher percentage of head-to tail thiophene linkages) than the method described in U.S. Pat. No. 6,166,172. Additionally, lower catalyst loading is needed, thus providing a less expensive procedure.

A variety of organometallic reagents can be used to form the thiophene-metal complex. Suitable organometallic reagents include Grignard reagents, Grignard-ate complexes, alkyl lithium reagents, alkyl lithium cuprates, alkyl aluminum reagents, and organozinc reagents (see, e.g., PCT Patent Application Publication No. WO 2007/011945, which is incorporated herein by reference). Commercial reagents, such as Grignard, Grignard-ate complexes, alkyl lithium, alkyl lithium cuprate, alkyl aluminum, and organozinc reagents can be employed, such as those disclosed in the Aldrich Handbook of Fine Chemicals, 2007-2008, Milwaukee, Wis. Any suitable amount of the organometallic reagent can be used. Typically, one to about five equivalents of the organometallic reagent can be employed, based on the amount of the thiophene starting material. The entire reaction sequence can be carried out without any isolation of intermediates.

The dihalo-thiophenes are typically difluoro-, dichloro-, dibromo-, or diiodo-thiophenes, but mixed 2,5-dihalosubstituted thiophenes can also be employed.

The solvent employed in the methods of the invention can be aprotic solvents. Suitable solvents include ethereal or polyethereal solvents. Examples of such solvents include ethyl ether, methyl-t-butyl ether, tetrahydrofuran (THF), dioxane, diglyme, triglyme, 1,2-dimethoxyethane (DME or glyme), and the like. A typical solvent is tetrahydrofuran.

### Catalysts

The catalyst employed in the method of the invention is a Ni(II) catalyst. An effective amount of the Ni(II) catalyst is employed, such that a sufficient amount of catalyst is employed to effect the reaction in less than about 5 days. Typically, this is an amount of about 0.01-10 mole percent (mol %), however, any amount of the Nickel(II) catalyst can be employed, such as 50 mol %, 100 mol %, or more. Typically, about 0.1 mol % Nickel(II) catalyst to about 5 mol % Nickel(II) catalyst is employed, or preferably, about 0.1 mol % Nickel(II) catalyst to about 3 mol % Nickel(II) catalyst is employed, based on the amount of thiophene monomer present.

Examples of suitable nickel(II) catalysts include, for example, Ni(PR₃)₂X₂ wherein R is (C₁-C₂₀)alkyl, (C₆-C₂₀)aryl, and X is halo; NiLX₂ wherein L is a suitable nickel(II) ligand and X is halo. Suitable nickel(II) ligands include 1,2-bis(diphenylphosphino)ethane, 1,3-diphenylphosphinopropane, [2,2-dimethyl-1,3-dioxolane-4,5-diyl)bis(methylene)] diphenylphosphine, bis(triphenylphosphine), and (2,2′-dipyridine) ligands. Other suitable Ni(II) catalysts include Ni(CN)₄⁻²; NiO; Ni(CN)₅⁻³; Ni₂Cl₈⁻⁴; NiF₂; NiCl₂; NiBr₂; NiI₂; NiAs; Ni(dmph)₂ wherein dmph is dimethylglyoximate; BaNiS; [NiX(QAS)]⁺ wherein X is halo and QAS is As(o-C₆H₄AsPh₂)₃; [NiP(CH₂CH₂CH₂AsMe₂)₃CN]⁺; [Ni(NCS)₆]⁻⁴; KNiX₃ wherein X is halo; [Ni(NH₃)₆]⁺²; and [Ni(bipy)₃]+² wherein bipy is bipyridine.

Typical nickel catalysts also include 1,2-bis(diphenylphosphino)ethane nickel(II) chloride (Ni(dppe)Cl₂); 1,3-diphenylphosphinopropane nickel(II) chloride (Ni(dppp)Cl₂); 1,5-cyclooctadiene bis(triphenyl) nickel; dibromo bis(triphenylphosphine) nickel; dichoro(2,2′-dipyridine) nickel; and tetrakis(triphenylphosophine) nickel(0).

General techniques and methods known by those of ordinary skill in the art can be used in methods of the invention, such as the various standard procedures for carrying out the polymerization, and for isolating and purifying the products.

### Polymer Structure and Properties

The improved polythiophenes of the invention prepared by the methods disclosed herein can be unsubstituted, 3-substituted, or 3,4-disubstituted thiophenes. These substituents can be any of the groups recited under the definition of substituents above. In one embodiment, the thiophene is a 3-substituted thiophene, wherein the substituent is an alkyl, alkylthio, alkylsilyl, or alkoxy group. The substituent can be optionally substituted with other functional groups, for example, and with out limitation, one to about five esters, ketones, nitriles, amines, halogens, aryl groups, heterocyclyl groups, and heteroaryl groups. The alkyl chain of the alkyl, alkylthio, alkylsilyl, or alkoxy group can also be interrupted by one or more heteroatoms, such as O, S, NP groups (wherein P is a substituent or a nitrogen protecting group), or combinations thereof.

It is often preferable to include substituents that improve the solubility of the polythiophene. Such substituents can preferably include groups that include at least about five or six carbon atoms, such as hexyl, hexoxy, hexylthio, and hexylsilyl groups. In another aspect of the invention, it can be preferable that the substituent directly attached to the 3-position is a heteroatom, such as a sulfur, silicon, oxygen, or nitrogen atom. The heteroatoms can be substituted with other appropriate groups, such as are described above in the definition of substituted. Heteroatoms at the 3-position of the thiophenes can further enhance the conductivity of the polythiophene by, for example, allowing for delocalization of the aromatic electrons of the thiophene ring systems and/or allowing for improved packing and optimized microstructure of the polymer, leading to improved charge carrier mobility. In a further aspect of the invention, it can be preferable to separate an aryl, heteroaryl, or heterocyclyl substituent from the thiophene ring by one or more (e.g., one to ten, one to five, or one to three) methylene groups, optionally interrupted by one or more heteroatoms (e.g., a polyethylene or polyethyleneimine group wherein the group includes about 2 to about 10 repeating units. Substituents at the 3-position of the thiophene monomer can improve the regioregularity of the product polythiophene by providing steric bulk that influences the regiochemistry of the polymerization.

The terminal groups (group at the 2- or 5-position of the terminal thiophene of the polymer) on the product polythiophene can be a hydrogen or a halogen. The terminal group of the polythiophene can also be an alkyl or functionalized alkyl group, which can be provided for by quenching the polymerization with an organometallic species, such as an organo-zinc reagent.

The average weight molecular weight of the polythiophenes prepared by the methods described herein can be about 5,000 to about 200,000, preferably about 20,000 to about 80,000, and more preferably about 40,000 to about 60,000, as determined by GPC using a polystyrene standard in tetrahydrofuran. The polydispersity index (PDI) can be about 1 to about 2.5, or preferably about 1.1 to about 2.4, or more preferably about 1.2 to about 2.2.

The regioregularity of the polymers prepared by the methods of the invention are typically at least about 87% without any purification after work-up. It was surprisingly discovered that by employing 1.2 equivalents of a manganese halide salt, a higher percent of regioregularity can be obtained. For example, by employing 1.2 equivalents of MnCl₂, based on the amount of 3-substituted thiophene starting material, an HT polythiophene of at least about 92% regioregularity was obtained. Simple purification techniques, such as Soxhlet extraction with hexanes can improve the regioregularity to greater than about 94%, preferably greater than about 95%, more preferably greater than about 97%, yet more preferably greater than about 98%, or even more preferably greater than about 99%.

The crude polythiophene can be isolated after polymerization by precipitation in methanol followed by simple filtration of the precipitated polymer. The crude polymer has superior properties relative to the crude products of the art. The crude polythiophene of the invention has higher regioregularity that the known preparatory methods, which reduces the amount of purification necessary to provide a usable material for electronic applications.

Higher regioregularity results in higher conductivity of the polythiophenes. When doped, a regioregular 3-substituted polythiophene can have a conductivity of about 1,000 seimens/cm, +/−about 400 seimens/cm. Regiorandom 3-substituted polythiophenes are typically conduct at only about 5-10 seimens/cm. Furthermore, undoped regioregular 3-substituted polythiophenes conduct at about 10⁻⁵ to about 10⁻⁶ seimens/cm (the semiconductor range), and undoped regiorandom polythiophenes conduct at about 10⁻⁹ seimens/cm.

Polythiophenes can be oxidatively or reductively doped. Dopants that can be included in the polythiophene polymer matrix include typical dopants used with conductive organic polymers, including iodine (I₂), bromine (Br₂), ferric chloride, and various arsenate or antimony salts. Other dopants include various known onium salts, iodonium salts, borate salts, tosylate salts, triflate salts and sulfonyloxyimides. The polythiophenes of the invention can be doped by dissolving the polymer in a suitable organic solvent and adding the dopant to the solution, followed by evaporation of the solvent. Many variations of this technique can be employed and such techniques are well known to those of skill in the art. See for example, U.S. Pat. No. 5,198,153.

The polymers of the invention can also include one or more other suitable components such as, for example, sensitizers, stabilizers, inhibitors, chain-transfer agents, co-reacting monomers or oligimers, surface active compounds, lubricating agents, wetting agents, dispersing agents, hydrophobing agents, adhesive agents, flow improvers, diluents, colorants, dyes, pigments, or dopants. These optional components can be added to a polymer composition by dissolving the polythiophene in a suitable organic solvent and adding the component to the solution, followed by evaporation of the solvent. In certain embodiments of the invention, the polythiophene polymers are significantly useful as substantially pure polymers or as a doped polymers.

### Thin Films

The high purity polymers prepared by the methods described herein can be used to form thin films. The thin films can be formed using standard methods known to those of skill in the art, such as spin coating, casting, dipping, bar coating, roll coating, and the like, using a solution of a polythiophene of the invention dissolved in a solvent. See for example, U.S. Pat. Nos. 5,892,244; 6,337,102; 7,049,631; 7,037,767; 7,025,277; 7,053,401; and 7,057,339 for methods of preparing thin films and organic field effect transistors. The thin films can have a wide range of thickness. A typical thin film is in the range of about 1 μm to about 1 mm. The thin film can include a coloring agent, a plasticizer, or a dopant. The polythiophenes of the invention can be electrically conductive, particularly when a dopant is included in the polymer matrix.

### Applications of the Regioregular Polythiophenes

The regioregular polythiophenes can be employed in the manufacture of organic light-emitting diodes (OLEDs). The OLEDs can be used in electronic displays. The regioregular polythiophenes can also be used to prepare radio frequency identification (RFID) tags. Regioregular poly(3-alkylthio-thiophenes) are especially useful for preparing thin films and organic field effect transistors (OFETs). The polythiophenes can further be used in, for example, optical, electrooptical, electric, electronic, charge transport, electroluminescent, or photoconductor materials, applications, and devices. Other applications include photovoltaic devices and plastic lighting. Further applications include their use in liquid crystal and/or semiconducting materials, devices, or applications. The increased conductance of these polymers compared to conventional syntheses allows for improved conductance, and therefore, improved function of these applications and devices.

The invention further relates to the polymers described herein in electrooptical displays, OLCDs, ELCDs, optical films, reflective films, electronic devices such as OFETs as components of integrated circuits, thin film transistors in flat or flexible panel display applications or for RFID tags, semiconducting or light-emitting components of organic light emitting diodes (OLED) applications, electroluminescent displays or backlights of LCDs, electrode materials in batteries, and the like.

The regioregular polythiophenes are particularly useful for use in plastic electronics, such as for preparing plastic RFID tags, plastic photovoltaic devices, plastic lighting devices, and OLEDs. Accordingly, the invention provides an electronic device comprising a circuit constructed with a polymer as described herein, such as a polymer prepared as described in any one of Examples 1-40.

It is to be understood that certain descriptions of the present invention have been simplified to illustrate only those elements and limitations that are relevant to a clear understanding of the present invention, while eliminating, for purposes of clarity, other elements. Those of ordinary skill in the art, upon considering the present description of the invention, will recognize that other elements and/or limitations may be desirable in order to implement the present invention. However, because such other elements and/or limitations may be readily ascertained by one of ordinary skill upon considering the present description of the invention, and are not necessary for a complete understanding of the present invention, a discussion of such elements and limitations is not provided herein. For example, as discussed herein, the materials of the present invention may be incorporated, for example, in electronic devices that are understood by those of ordinary skill in the art, and, accordingly, are not described in detail herein.

Furthermore, compositions of the present invention may be generally described and embodied in forms and applied to end uses that are not specifically and expressly described herein. For example, one skilled in the art will appreciate that the present invention may be incorporated into electronic devices other than those specifically identified herein.

### EXAMPLES

The following Examples are illustrative of the above invention. One skilled in the art will readily recognize that the techniques and reagents described in the Examples suggest many other ways in which the present invention could be practiced. It should be understood that many variations and modifications may be made while remaining within the scope of the invention.

Other than in the operating examples, or unless otherwise expressly specified, all of the numerical ranges, amounts, values and percentages such as those for amounts of materials, times and temperatures of reaction, ratios of amounts, and others in the following portion of the specification may be read as if prefaced by the word “about” even though the term “about” may not expressly appear with the value, amount, or range. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values inclusive of the recited values may be used.

Reactions were typically carried out on a dual manifold vacuum/argon or nitrogen system. The handling of air-sensitive materials was performed under argon or nitrogen in a dry box when necessary. Chemical reagents were primarily purchased from Aldrich Chemical Co., Inc.(Milwaukee, Wis.), and were used as received unless indicated otherwise.

### Example 1

### Preparation of Regioregular HT Poly(3-hexylthiophene) from 2,5-Dibromo-3-hexylthiophene and alkyl Grignard in the presence of Manganese Chloride

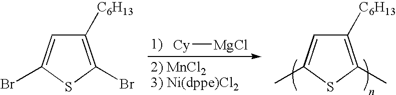

A 250 mL of round-bottom-flask was charged with 2,5-dibromo-3-hexylthiophene (8.15 grams (g), 25 mmol) and 50 mL of tetrahydrofuran. The reaction flask was cooled in an ice-bath. With stirring at 0° C., cyclohexylmagnesium chloride (2.0 M in ether, 12.5 mL, 25 mmol) was slowly added into the reaction flask. After being stirred at 0° C. for 10 minutes, manganese chloride (0.5 M in tetrahydrofuran, 50 mL, 25 mmol) was added to the reaction mixture, which was allowed to warm to room temperature over 20 minutes. Stirring was discontinued and solids settled to the bottom of the reaction vessel. Without transferring the solids, the reaction solution was cannulated to a flask containing Ni(dppe)Cl₂ (0.04 g, 0.3 mol %) in 10 mL of tetrahydrofuran at room temperature. The resulting mixture was stirred at room temperature for 24 hours. A dark-purple precipitate gradually formed over the course of the 24 hours. The entire mixture was then poured into 100 mL of methanol. The resulting dark precipitate was filtered, washed with methanol, and then dried under high vacuum.

The regioregularity of the polythiophene obtained was about 87%, as determined by ¹H NMR analysis.

The average weight molecular weight of the regioregular HT poly(3-substituted-thiophene) was about 40,000 to about 60,000 as determined by GPC using a polystyrene standard in tetrahydrofuran. Light-scatting analysis indicates the average weight molecular weight is much higher, in the range of about 80,000 to about 120,000.

### Example 2

### Preparation of Regioregular HT Poly(3-hexylthiophene) from 2,5-Dibromo-3-hexylthiophene and alkyl Grignard in the presence of Manganese Chloride

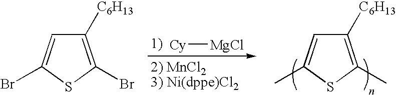

A 250 mL of round-bottom-flask was charged with 2,5-dibromo-3-hexylthiophene (8.15 g, 25 mmol) and 50 mL of tetrahydrofuran. The reaction flask was cooled in an ice-bath. With stirring at 0° C., cyclohexylmagnesium chloride (2.0 M in ether, 12.5 mL, 25 mmol) was slowly added into the reaction flask. After being stirred at 0° C. for 10 minutes, manganese chloride (0.5 M in tetrahydrofuran, 60 mL, 30 mmol) was added to the reaction mixture, which was allowed to warm to room temperature over 20 minutes. Stirring was discontinued and solids settled to the bottom of the reaction vessel. Without transferring the solids, the reaction solution was cannulated to a flask containing Ni(dppe)Cl₂ (0.04 g, 0.3 mol %) in 10 mL of tetrahydrofuran at room temperature. The resulting mixture was stirred at room temperature for 24 hours. A dark-purple precipitate gradually formed over the course of the 24 hours. The entire mixture was then poured into 100 mL of methanol. The resulting dark precipitate was filtered, washed with methanol, and then dried under high vacuum.

Similar results were obtained as in Example 1, with the exception that by employing 1.2 equivalents of MnCl₂, the regioregularity of the crude polymer increased to about 92%.

### Example 3

### Comparative Example

Poly(3-hexylthiophene) was prepared by the method as substantially described in U.S. Pat. No. 6,166,172 for the preparation of poly(3-dodecylthiophene). A sample of 2,5-dibromo-3-hexylthiophene was dissolved in tetrahydrofuran, methyl magnesium bromide (1.3 equivalent) was added, and the mixture was refluxed for six hours. The catalyst Ni(dppp)Cl₂ (1 mol %) was added and the solution was then refluxed for two hours. The crude poly(3-hexyl-thiophene) was isolated and was found to possess 89% HT couplings, as determined by ¹H NMR analysis (analysis and integration of the C-4 vinyl proton and the C-3 α-methylene protons). The purification procedure of Example 1 of the '172 patent (Soxhlet extraction with three different organic solvents) was not conducted in order to provide a direct comparison with the crude poly(3-hexylthiophene) prepared by the methods described herein.

As a comparison to the method described in the '172 patent, poly(3-hexylthiophene) was prepared by the method described in Example 1 above with the following variations. Cyclohexylmagnesium chloride and MnCl₂ (1.5 equivalent each) were employed and the polymerization was carried out starting at 0° C., and cooling bath was allowed to warm to room temperature. As in Example 1, only 0.3 mol % of Ni(dppe)Cl₂ catalyst was employed. The crude poly(3-hexylthiophene) was isolated and was found to possess 92% HT couplings, as determined by ¹H NMR analysis.

By direct comparison of these two techniques, it was found that employing the manganese transmetallation technique afforded a poly(3-hexylthiophene) with an increased HT coupling of about 3%. This increased HT purity results in less time, solvent, energy, and expense required to purify the product for use in the various devices described herein.

### Examples 4-39

### Preparation of Regioregular HT Poly(3-hexylthiophene

A. Preparation of Thienylmanganese Chloride Reagents

To an oven-dried 250 mL round-bottomed flask was added 6.52 grams (20 mmol) 2,5-dibromo-3-hexylthiophene and 40 mL of tetrahydrofuran. The flask was cooled to 0° C. in an ice bath with stirring and 10 mL (20 mmol) isopropylmagnesium chloride (2.0 M in tetrahydrofuran) was added with a syringe. The mixture was stirred at 0° C. for 5 minutes to afford the thienyl-Grignard solution.

To another oven-dried 250 mL round-bottomed flask was added 2.8 grams (22 mmol) MnCl₂ and 40 mL of tetrahydrofuran and stirred at room temperature. To this was added via a cannula, the above thienyl-Grignard solution to obtain a gold-colored mixture. The solution was stirred at room temperature for twelve hours and allowed to settle overnight to afford a gold-colored liquid and a yellow precipitate (the thienylmanganese chloride reagent).

B. Preparation of Thienylmanganese Bromide Reagents

MnBr₂ was substituted for MnCl₂ in the above procedure to afford the thienylmanganese bromide reagent.

C. Polymerization of Organomanganese Reagents with the Reverse-Addition Procedure (Addition of Ni(II) Catalyst into the Organomanganese Solution)

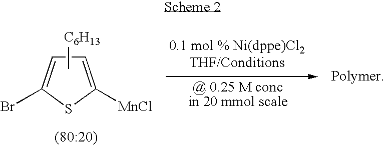

The thienylmanganese chloride prepared above was placed in an oven-dried 250 ml round-bottomed flask and cooled to 0° C. in an ice-bath. To this was added 0.1 gram (0.1 mol %) Ni(dppe)Cl₂ in one portion with a powder addition funnel. The mixture was stirred at 0° C. for 4-5 hours to form a polymer precipitate, warmed gradually to room temperature, and stirred at room temperature for an additional 19-20 hours. The mixture was poured into 80 ml methanol and stirred for 20 minutes. The polymer precipitate was filtered with a Buchner funnel, washed with methanol, and dried under a high vacuum to afford Examples 4-28 in Table 1.

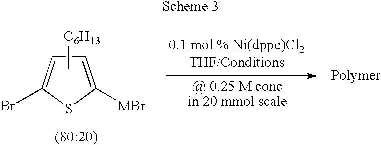

Examples 29-36 in Table 2 were also prepared with this procedure by substituting thienylmanganese bromide for thienylmanganese chloride.

D. Polymerization of Organomanganese Reagents with the Standard Addition Procedure (Addition of Organomanganese Solution into the Ni(II) Catalyst)

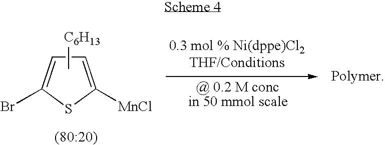

To a solution of 0.1 gram (0.1 mol %) Ni(dppe)Cl₂ in tetrahydrofuran was added the 0° C. solution of thienylmanganese chloride prepared above. The mixture was stirred at 0° C. for 4-5 hours to form a polymer precipitate, warmed gradually to room temperature, and stirred at room temperature for an additional 19-20 hours. The mixture was poured into 80 ml methanol and stirred for 20 minutes. The polymer precipitate was filtered with a Buchner funnel, washed with methanol, and dried under a high vacuum to afford Examples 29-31 in Table 3.

E. Purification of Poly(thiophene

A. Preparation of the L-grade poly(thiophene).

The crude polymer was placed in a Soxhlet thimble and extracted with hexanes for 24 hours. The polymer was dried under high vacuum to afford Examples 4, 6, 8, 10-11, 13, 16, and 19-20 in Table 1.

B. Preparation of the 4002 grade poly(thiophene).

The L-grade poly(thiophene) prepared above was placed in another Soxhlet thimble and extracted with chloroform until the polymer was removed from the thimble. The solution was concentrated under reduced pressure until polymer was observed on the wall of the flask. The residue was poured into approximately double the volume of hexanes with stirring. The polymer was filtered with a Buchner funnel, washed with hexanes, and dried under a high vacuum to afford Examples 6, 10, 15, 17, and 23 in Table 1.

C. Preparation of the E-grade poly(thiophene).

The 4002 grade poly(thiophene) prepared above was placed in another Soxhlet thimble and extracted with chloroform until the polymer was removed from the thimble. The solution was concentrated under reduced pressure until polymer was observed on the wall of the flask. The residue was poured into methanol with stirring. The polymer was filtered with a Buchner funnel, washed with methanol, and dried under a high vacuum to afford Examples 10, 15, and 22 in Table 1.

TABLE 1
Reverse-Addition Procedure using Thienylmanganese Chloride

| | | | ¹H NMR Analysis | | | |
|---|---|---|---|---|---|---|
| | | Yield | | | | E- |
| Example | Conditions | (%) | Crude | L-grade | 4002 | grade |
| 4 | 0° C. for 6 hours | 40 | 95:5 | 97:3 | | |
| 5 | 0° C. for 6 hours with 10% | 39 | | | | |
| | TFT* | | | | | |
| 6 | 0° C. to 23° C. for 24 hours | 94 (78)** | 93:7 | 96:4 | 95:5 | |
| 7 | 0° C. to 23° C. for 24 hours | 82 | | | | |
| 8 | 0° C. to 23° C. for 24 hours | 73 (60) | | 97:3 | | |
| | with 10% TFT | | | | | |
| 9 | 0° C. to 23° C. for 24 hours | 48 | | | | |
| | with @ 0.5 M | | | | | |
| 10 | 0° C. to 23° C. for 24 hours | 66 (57) | 94:6 | 95:5 | 96:4 | 96:4 |
| | with @ 0.5 mol | | | | | |
| 11 | 23° C. for 24 hours | 64 | 82:18 | 94:6 | | |
| 12 | 23° C. for 24 hours | 76 | 91:9 | | | |
| 13 | 23° C. for 3 hours | 70 | 89:11 | 95:5*** | | |
| 14 | 23° C. for 3 hours/q.w/aq- | 61 | 92:8 | 95:5 and | | |
| | MeOH Solution | | | 95:5*** | | |
| 15 | 23° C. for 24 hours with 80 mmol | 65 (60) | 90:10 | | 97:3 | 96:4 |
| 16 | 23° C. for 24 hours with 0.1 M | 78 | 93:7 | 96:4 | | |
| 17 | 23° C. for 24 hours with 0.1 | 83 (74) | | | 94:6 | |
| | M and 80 mmol | | | | | |
| 18 | 23-36° C. for 24 hours | 73 | 92:8 | | | |
| 19 | 23° C. to reflux for 24 hours | 82 | 92:8 | 95:5 | | |
| 20 | 23° C. for 24 hours with | 6 | | | | |
| | NMP | | | | | |
| 21 | 23° C. for 24 hours with 10 mol | 73 (57 | | | | |
| | % TFT | | | | | |
| 22 | 23° C. for 24 hours with 10% | 91 (68) | | 95:5 | | |
| | TFT | | | | | |
| 23 | 23° C. for 24 hours with 10% | 65 (47) | | 92:8 | 93:7 | 94:6 |
| | TFT and 200 mmol | | | | | |
| 24 | 23° C. for 24 hours at 0.05 mol | 61 | 91:9 | | | |
| | % Ni | | | | | |
| 25 | Ni(PPh₃)₂Cl₂ | n/a**** | | | | |
| 26 | Ni(PMe₃)₂Cl₂ | n/a | | | | |
| 27 | Fe(dppe)Cl₂ | n/a | | | | |
| 28 | Co(dppe)Cl₂ | n/a | | | | |

*TFT = α,α,α-trinitrofluorotoluene
**= Soxholet Extraction
***= simple washing
****n/a = not available

TABLE 2
Reverse-Addition Procedure using Thienylmanganese Bromide

| | | | ¹H NMR Analysis | | | |
|---|---|---|---|---|---|---|
| | | Yield | | L- | | E- |
| Example | Conditions | (%) | Crude | grade | 4002 | grade |
| 29 | 0° C. for 6 hours | 36 | 87:13 | | | |
| 30 | 0 to 23° C. for 24 hours | 56 | 90:10 | 96:4 | | |
| 31 | 23° C. for 24 hours | 51 | 89:11 | | | |
| 32 | 23° C. for 3 hours | 70 (55)** | | 96:4 | 95:5 | |
| 33 | 23° C. for 24 hours and 200 mmol | 55 (40) | | 93:7 | 93:7 | 94:6 |
| 34 | 23° C. for 24 hours and 0.05 mmol | 42 | | | | |
| | % Ni | | | | | |
| 35 | 23° C. for 24 hours and 10% | 64 (40) | | 94:6 | | |
| | TFT* | | | | | |
| 36 | Reflux for 24 hours | 55 (39) | | 94:6 | | |

*TFT = α,α,α-trinitrofluorotoluene
**= Soxholet Extraction

TABLE 3
Standard Addition Procedure

| | | | ¹H NMR Analysis | | |
|---|---|---|---|---|---|
| Example | Conditions | Yield (%) | Crude | L-grade | 4002 |
| 37 | 0 to 23° C. for | 72 | 92:8 | 95:5 | |
| | 24 hours | | | | |
| 38 | 23° C. for 24 hours | 78 | | 92:8 | |
| 39 | 23° C. to reflux for | 63 | 85:15 | 87:13 | |
| | 24 hours | | | | |

The results in Tables 1-3 suggest that: a) a lower reaction temperature affords a higher regioregularity of the polymer (see, e.g., Table 1), b) the reverse addition procedure of Schemes 2-3 afford an easier work-up procedure; c) the thienyl-Grignard reagent may be prepared at either 0° C. or at room temperature to afford a 80:20 ratio at 0° C., d) a suspension of manganese halide in tetrahydrofuran was used because manganese halide was not totally soluble in tetrahydrofuran at room temperature, e) no big advantage was observed using manganese bromide instead of manganese chloride, f) the ratio of 5- and 2-thienylmanganese reagents was not a major factor in determining the regioregularity of the polymer, and g) the reverse addition procedure and lower reaction temperature are the preferred conditions for polymerization.

### Example 40

### Exemplary poly(3-substituted-thiophenes)

Scheme 5 illustrates several of the polythiophenes that can be prepared by the methods described herein, wherein n is a value such that the polythiophene polymer as a molecular weight of about 10,000 to about 200,000; “Hex” is hexyl but can be any alkyl group as described herein; “Bn” is benzyl which can be optionally substituted as described herein; “Ar” is aryl as described herein; “Het” is heteroaryl or heterocyclyl as described herein; m is 1 to about 20; and R is alkyl as described herein.

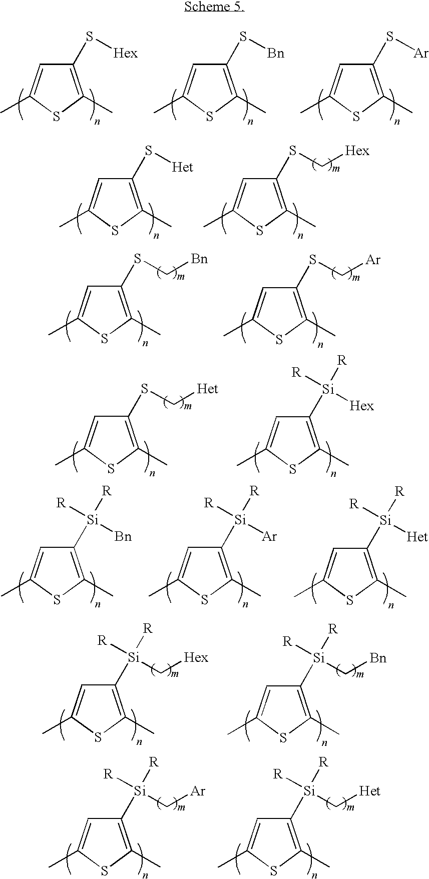

All publications, patents, and patent documents are incorporated by reference herein, as though individually incorporated by reference. The invention has been described with reference to various specific and preferred embodiments and techniques. However, it should be understood that many variations and modifications may be made while remaining within the spirit and scope of the invention.

1. A method of preparing regioregular HT poly(3-substituted-thiophene) comprising:
a) contacting a 3-substituted-thiophene-metal complex with a manganese(II) halide to provide a 3-substituted-thiophene-manganese complex; and
b) contacting the 3-substituted-thiophene-manganese complex with a nickel(II) catalyst to provide the regioregular HT poly(3-substituted-thiophene),
wherein the 3-substituted-thiophene-metal complex is a 3-substituted-5-halo-thiophene metal complex, a 3-substituted-2-halo-thiophene metal complex, or a mixture thereof.

2. The method of claim 1 wherein the 3-substituted-thiophene-metal complex is prepared by a method comprising contacting a 2,5-dihalo-3-substituted-thiophene and an organometallic reagent to provide the 3-substituted-thiophene-metal complex.

3. The method of claim 2 wherein the organometallic reagent is a Grignard reagent, a Grignard-ate complex, an alkyl lithium reagent, an alkyl lithium cuprate, an alkyl aluminum reagent, or an organozinc reagent.

4. The method of claim 1 wherein the 3-substituted-thiophene-manganese complex is contacted with the nickel(II) catalyst at about −80° C. to about 35° C.

5. The method of claim 1 wherein the 3-substituted-thiophene-manganese complex is contacted with the nickel(II) catalyst at about −10° C. to about 30° C.

6. The method of claim 1 wherein the 3-substituted-thiophene-manganese complex is contacted with the nickel(II) catalyst at about 0° C. to about 27° C.

7. The method of claim 1 wherein the regioregularity of the regioregular HT poly(3-substituted-thiophene) is greater than about 87%.

8. The method of claim 1 wherein the regioregularity of the regioregular HT poly(3-substituted-thiophene) is greater than about 92%.

9. The method of claim 1 wherein the regioregularity of the regioregular HT poly(3-substituted-thiophene) is greater than about 95%.

10. The method of claim 1 wherein the regioregular HT poly(3-substituted-thiophene) is substituted with an alkyl, alkylthio, alkylsilyl, or alkoxy group that is optionally substituted with one to about five ester, ketone, nitrile, amino, aryl, heteroaryl, or heterocyclyl groups, and the alkyl chain of the alkyl group is optionally interrupted by one to about ten O, S, or NH groups.

11. The method of claim 1 wherein the regioregular HT poly(3-substituted-thiophene) is substituted with a straight-chain, branched-chain, or cyclic (C₁-C₃₀)alkyl group.

12. The method of claim 1 wherein the regioregular HT poly(3-substituted-thiophene) is substituted with a straight-chain (C₁-C₁₂)alkyl group.

13. The method of claim 1 wherein the regioregular HT poly(3-substituted-thiophene) is substituted with a hexyl group.

14. The method of claim 1 wherein the regioregular HT poly(3-substituted-thiophene) is substituted with a straight-chain, branched-chain, or cyclic (C₁-C₃₀)alkylthio group.

15. The method of claim 1 wherein the regioregular HT poly(3-substituted-thiophene) is substituted with a straight-chain (C₁-C₁₂)alkylthio group.

16. The method of claim 1 wherein the regioregular HT poly(3-substituted-thiophene) is substituted with a hexylthio group.

17. The method of claim 1 wherein the regioregular HT poly(3-substituted-thiophene) is substituted with a straight-chain, branched-chain, or cyclic (C₁-C₃₀)alkoxy group.

18. The method of claim 1 wherein the regioregular HT poly(3-substituted-thiophene) is substituted with a straight-chain (C₁-C₁₂)alkyloxy group.

19. The method of claim 1 wherein the regioregular HT poly(3-substituted-thiophene) is substituted with a hexoxy group.

20. The method of claim 1 wherein average weight molecular weight of the regioregular HT poly(3-substituted-thiophene) is about 5,000 to about 200,000.

21. The method of claim 1 wherein average weight molecular weight of the regioregular HT poly(3-substituted-thiophene) is about 40,000 to about 60,000.

22. The method of claim 1 wherein the regioregular HT poly(3-substituted-thiophene) prepared has a polydispersity index of about 1 to about 2.5.

23. The method of claim 1 wherein the regioregular HT poly(3-substituted-thiophene) prepared has a polydispersity index of about 1.2 to about 2.2.

24. The method of claim 2 wherein the 2,5-dihalo-3-substituted-thiophene is a 2,5-dichloro-3-substituted-thiophene, a 2,5-dibromo-3-substituted-thiophene, or a 2,5-diiodo-3-substituted-thiophene.

25. The method of claim 2 wherein the 2,5-dihalo-3-substituted-thiophene is a 2,5-dibromo-3-substituted-thiophene.

26. The method of claim 2 wherein the organometallic reagent is a Grignard reagent.

27. The method of claim 26 wherein the Grignard reagent is a (C₁-C₃₀)alkyl magnesium halide or a (C₆-C₁₄)aryl magnesium halide.

28. The method of claim 26 wherein the Grignard reagent is a (C₅-C₆)alkyl magnesium halide or a phenyl magnesium halide.

29. The method of claim 26 wherein the Grignard reagent is a cyclopentyl magnesium halide, a cyclohexyl magnesium halide, or a phenyl magnesium halide.

30. The method of claim 26 wherein the Grignard reagent is a magnesium fluoride, magnesium chloride, a magnesium bromide, or a magnesium iodide.

31. The method of claim 26 wherein the Grignard reagent is cyclopentyl magnesium chloride, cyclohexyl magnesium chloride, or phenyl magnesium chloride.

32. The method of claim 2 wherein the organometallic reagent is an alkyl lithium reagent or an aryl lithium reagent.

33. The method of claim 32 wherein the organometallic reagent is a (C₁-C₃₀)alkyl lithium or a (C₆-C₁₄)aryl lithium.

34. The method of claim 32 wherein the organometallic reagent is a (C₁-C₆)alkyl lithium or phenyl lithium.

35. The method of claim 32 wherein the organometallic reagent is methyl lithium, cyclohexyl lithium, or phenyl lithium.

36. The method of claim 1 wherein the a manganese(II) halide is manganese chloride, manganese bromide, manganese iodide, or manganese fluoride.

37. The method of claim 1 wherein the a manganese(II) halide is manganese chloride.

38. The method of claim 1 wherein the nickel(II) catalyst comprises phosphine ligands.

39. The method of claim 1 wherein the nickel(II) catalyst comprises halide ligands.

40. The method of claim 1 wherein the nickel(II) catalyst is, or is derived from, Ni(dppe)Cl₂, Ni(dppp)Cl₂, Ni(PPh₃)₂Br₂, 1,5-cyclooctadienebis(triphenyl) nickel, dichoro(2,2′-dipyridine) nickel, tetrakis(triphenylphosophine) nickel, NiO, NiF₂, NiCl₂, NiBr₂, NiI₂, NiAs, Ni(dmph)₂, BaNiS, or a combination thereof.

41. The method of claim 40 wherein the nickel(II) catalyst is Ni(dppe)Cl₂ or Ni(dppp)Cl₂.

42. The method of claim 1 wherein a sub-stoichiometric amount of nickel(II) catalyst is employed.

43. The method of claim 1 wherein about 0.01 mol % to about 100 mol % of nickel(II) catalyst is employed.

44. The method of claim 1 wherein about 0.1 mol % to about 5 mol % of nickel(II) catalyst is employed.

45. The method of claim 1 wherein about 0.1 mol % to about 3 mol % of nickel(II) catalyst is employed.

46. The method of claim 1 wherein about 1 to about 2 equivalents of the manganese(II) halide are employed, with respect to the 3-substituted-thiophene-metal complex.

47. The method of claim 1 wherein about 1.0 to about 1.5 equivalents of the manganese(II) halide are employed, with respect to the 3-substituted-thiophene-metal complex.

48. The method of claim 2 wherein about 1 to about 5 equivalents of the organometallic reagent are employed, with respect to the 2,5-dihalo-3-substituted-thiophene.

49. A method of preparing poly(thiophene) comprising:
a) contacting a thiophene-metal complex with a manganese(II) halide to provide a thiophene-manganese complex; and
b) contacting the thiophene-manganese complex with a nickel(II) catalyst to provide the poly(thiophene),
wherein the thiophene-metal complex is a 5-halo-thiophene metal complex, a 2-halo-thiophene metal complex, or a mixture thereof.

50. A method of preparing poly(thiophene) comprising:
a) contacting a 2,5-dihalo-thiophene and an organometallic reagent to provide a thiophene-metal complex;
b) contacting the thiophene-metal complex with a manganese(II) halide to provide a thiophene-manganese complex; and
c) contacting the thiophene-manganese complex with a nickel(II) catalyst to provide the poly(thiophene).

51. The method of claim 50 wherein the organometallic reagent is a Grignard reagent, a Grignard-ate complex, an alkyl lithium reagent, an alkyl lithium cuprate, an alkyl aluminum reagent, or an organozinc reagent.

52. A method of preparing poly(3,4-disubstituted-thiophene) comprising:
a) contacting a 3,4-disubstituted-thiophene-metal complex with a manganese(II) halide to provide a 3,4-disubstituted-thiophene-manganese complex; and
b) contacting the 3,4-disubstituted-thiophene-manganese complex with a nickel(II) catalyst to provide the poly(3,4-disubstituted-thiophene),
wherein the 3,4-disubstituted-thiophene-metal complex is a 3,4-disubstituted-5-halo-thiophene metal complex, a 3,4-disubstituted-2-halo-thiophene metal complex or a mixture thereof.

53. A method of preparing poly(3,4-disubstituted-thiophene) comprising:
a) contacting a 2,5-dihalo-3,4-substituted-thiophene and organometallic reagent to provide a 3,4-disubstituted-thiophene-metal complex;
b) contacting the 3,4-disubstituted-thiophene-metal complex with a manganese(II) halide to provide a 3,4-disubstituted-thiophene-manganese complex; and
c) contacting the 3,4-disubstituted-thiophene-manganese complex with a nickel(II) catalyst to provide the poly(3,4-disubstituted-thiophene).

54. The method of claim 53 wherein the organometallic reagent is a Grignard reagent, a Grignard-ate complex, an alkyl lithium reagent, an alkyl lithium cuprate, an alkyl aluminum reagent, or an organozinc reagent.

55. The method of claim 52 wherein the substituents of the poly(3,4-substituted-thiophene) are the same.

56. The method of claim 52 wherein the substituents of the poly(3,4-substituted-thiophene) are not the same.

57. The method of claim 52 wherein the poly(3,4-substituted-thiophene) monomers are arranged in a substantially HT orientation.

58. A regioregular HT poly(3-substituted-thiophene) prepared by a method comprising:
a) contacting a 2,5-dihalo-3-substituted-thiophene and a Grignard reagent to provide a 3-substituted-thiophene-magnesium complex;
b) contacting the 3-substituted-thiophene-magnesium complex with a manganese(II) halide to provide a 3-substituted-thiophene-manganese complex; and
c) contacting the 3-substituted-thiophene-manganese complex with a nickel(II) catalyst to provide the regioregular HT poly(3-substituted-thiophene).

59. An electronic device comprising a circuit constructed with the regioregular HT polythiophene prepared by the method of claim 1.

60. The electronic device of claim 59 wherein the device is an RFID tag, a plastic photovoltaic device, a plastic lighting device, or an OLED.

61. A regioregular HT poly(3-substituted-thiophene) prepared by claim 1.

62. The regioregular HT poly(3-substituted-thiophene) of claim 61 wherein the crude regioregular HT poly(3-substituted-thiophene) has a regioregularity of at least about 87%.

63. The regioregular HT poly(3-substituted-thiophene) of claim 62 wherein the crude regioregular HT poly(3-substituted-thiophene) has a regioregularity of at least about 92%.

64. The regioregular HT poly(3-substituted-thiophene) of claim 63 wherein the crude regioregular HT poly(3-substituted-thiophene) has a regioregularity of at least about 87%.

65. The regioregular HT poly(3-substituted-thiophene) of claim 61 in the form of a thin film.

66. A conductive polymer comprising HT poly(3-substituted-thiophene) having at least about 92% regioregularity; an average weight molecular weight of about 30,000 to about 70,000; and a conductance of about 10⁻⁵ to about 10⁻⁶ seimens/cm.

67. The conductive polymer of claim 66 wherein the substituent of the HT poly(3-substituted-thiophene) is an organic or inorganic group.

68. The conductive polymer of claim 67 wherein the substituent of the HT poly(3-substituted-thiophene) is an alkyl, alkylthio, alkylsilyl, or alkoxy group that is optionally substituted with one to about five ester, ketone, nitrile, amino, aryl, heteroaryl, or heterocyclyl groups, and the alkyl chain of the alkyl group is optionally interrupted by one to about ten O, S, or NH groups.

69. The method of claim 1 wherein the 3-substituted-thiophene-manganese complex is added to the nickel(II) catalyst.

70. The method of claim 1 wherein the nickel(II) catalyst is added to the 3-substituted-thiophene-manganese complex.

71. The regioregular HT poly(3-substituted-thiophene) of claim 58 wherein the 3-substituted-thiophene-manganese complex is added to the nickel(II) catalyst.

72. The regioregular HT poly(3-substituted-thiophene) of claim 58 wherein the nickel(II) catalyst is added to the 3-substituted-thiophene-manganese complex.
